(19) United States
(12) Patent Application Publication
(10) Pub. No.: US 2019/0207508 A1
(43) Pub. Date: Jul. 4, 2019

(54) INVERTER DEVICE

(71) Applicant: Sanden Automotive Components Corporation, Isesaki-shi, Gunma (JP)

(72) Inventors: Takeo TSUKAMOTO, Isesaki-shi, Gunma (JP); Daisuke HIRONO, Isesaki-shi, Gunma (JP)

(21) Appl. No.: 15/772,727

(22) PCT Filed: Nov. 29, 2016
(86) PCT No.: PCT/JP2016/085396

§ 371 Date: May 1, 2018

(30) Foreign Application Priority Data
Nov. 30, 2015 (JP) 2015-233648

(51) Int. Cl. H02M 1/32; H02M 7/5387; H02M 1/14; H02P 27/08; H02P 29/028; H02P 21/22

(52) U.S. Cl. CPC H02M 1/32; H02M 7/53871; H02M 1/14; H02M 2001/325; H02P 29/028; H02P 21/22; H02P 27/08

(57) ABSTRACT

An inverter device that generates an AC voltage from a DC voltage and drives an electric motor 2 includes: smoothing capacitors 3 for reducing the ripple voltage superimposed on the DC voltage; an inverter circuit 4 having a plurality of switching elements 40u to 40w, 41u to 41w; and a control unit 5 for controlling operation of the plurality of switching elements 40u to 40w, 41u to 41w of the inverter circuit 4. When an open fault has occurred in the smoothing capacitors 3, the control unit 5 limits the electric current flowing through the electric motor 2 by controlling the operation of the plurality of switching elements 40u to 40w, 41u to 41w.

### TECHNICAL FIELD

The present invention relates to an inverter device that generates an AC voltage from a DC voltage and controls operation of an electric motor, and specifically relates to an inverter device including a smoothing capacitor for reducing a ripple voltage superimposed on the DC voltage.

### BACKGROUND ART

As an inverter device of this type, the inverter device as disclosed in Patent Document 1 is well known, for example. In the inverter device of Patent Document 1, the abnormality detection circuit, which is connected in parallel with the smoothing capacitor, is used to determine whether or not an abnormality, such as blowout of a fuse or open-phase operation of the power supply, has occurred in the inverter device, by determining whether or not the value of the ripple voltage superimposed on the DC voltage falls within a range defined by upper and lower limits.

### REFERENCE DOCUMENT LIST

### Patent Document

Patent Document 1: JP H5-43800 U

### SUMMARY OF THE INVENTION

### Problem to be Solved by the Invention

Here, examples of abnormalities that potentially occur in an inverter device include an open fault in the smoothing capacitor. Even after an open fault has occurred in the smoothing capacitor, the inverter device is still capable of driving the electric motor. However, when an open fault has occurred in the smoothing capacitor, if an electric current as large as that set during normal operation is supplied to the electric motor, the ripple voltage superimposed on the DC voltage increases, and may adversely affect electronic components and/or the like surrounding the inverter device. In view of the above, an object of the present invention is to provide an inverter device capable of driving an electric motor as long as possible while protecting the inductor and the electronic components and/or the like surrounding the inverter device even after an open fault has occurred in the smoothing capacitor.

### Means for Solving the Problem

According to an aspect of the present invention, an inverter device that generates an AC voltage from a DC voltage and drives an electric motor comprises a smoothing capacitor for reducing a ripple voltage superimposed on the DC voltage, and, when an open fault has occurred in the smoothing capacitor, the inverter device drives the electric motor while limiting an electric current flowing through the electric motor such that the ripple voltage of the DC voltage does not exceed a preset allowable value.

### Effects of the Invention

When an open fault has occurred in the smoothing capacitor, the above inverter device limits an electric current flowing through the electric motor such that the ripple voltage of the DC voltage does not exceed the preset allowable value. Thus, the inverter device is capable of driving the electric motor as long as possible while protecting the inductor and the electronic components and/or the like surrounding the inverter device from adverse effects of the ripple voltage even after an open fault has occurred in the smoothing capacitor.

### BRIEF DESCRIPTION OF THE DRAWINGS

FIG. 1 is a circuit diagram showing a schematic configuration of an inverter device according to an embodiment.

FIG. 2 is a circuit diagram showing another schematic configuration of the inverter device.

FIG. 3 is a block diagram showing a control circuit for the limited electric current mode in the control unit of the inverter device.

FIG. 4 is a flowchart showing the procedure for switching to the limited electric current mode. FIG. 5 is a flowchart showing the procedure for switching to the limited electric current mode according to another embodiment.

### MODES FOR CARRYING OUT THE INVENTION

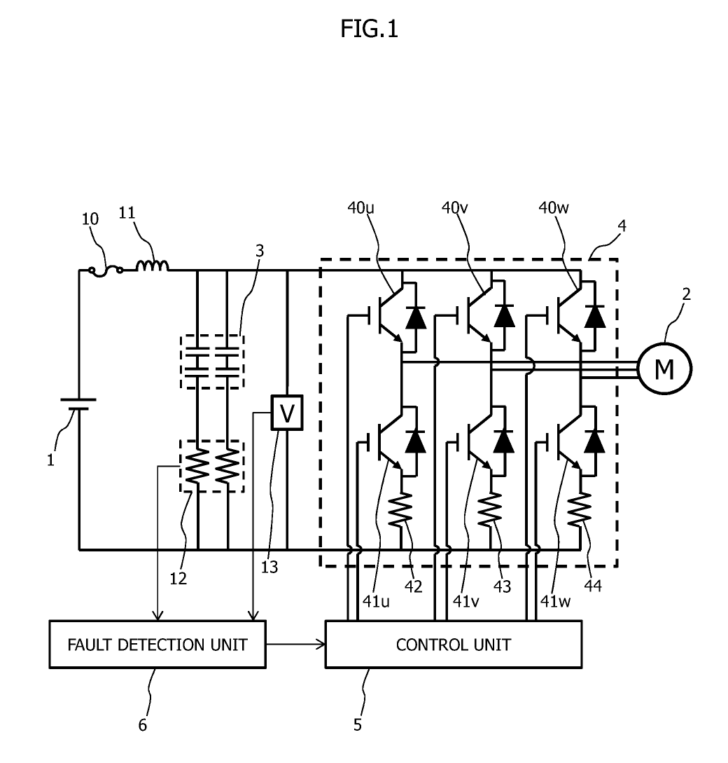

With reference to the accompanying drawings, embodiments of the present invention will be described below. FIG. 1 is a circuit diagram showing a schematic configuration of an inverter device according to an embodiment. The inverter device is disposed in a housing of an electric compressor, which is used in, for example, an air conditioner for a vehicle. As shown in FIG. 1, the inverter device generates an alternating-current (AC) voltage from a direct-current (DC) voltage supplied by a power supply (battery) 1 of the vehicle, and drives an electric motor 2.

The inverter device includes smoothing capacitors 3, an inverter circuit 4, a control unit 5, and a fault detection unit 6. The smoothing capacitors 3 reduce the ripple voltage superimposed on the DC voltage. The inverter circuit 4 has a plurality of switching elements. The control unit 5 controls the operation of the plurality of switching elements of the inverter circuit. The fault detection unit 6 detects an open fault of the smoothing capacitors 3.

The smoothing capacitors 3 are connected in parallel with the battery 1. In this embodiment, the number of the smoothing capacitors 3 is four. Each two of the four smoothing capacitors are connected in series with each other, and constitute a smoothing capacitor pair. Furthermore, these two smoothing capacitor pairs are connected in parallel with each other (see FIG. 1). For example, film capacitors, electrolytic capacitors, or the like are used as the smoothing capacitors 3.

In this embodiment, a fuse 10 is connected in series with the battery 1. When a short circuit fault has occurred in the smoothing capacitors 3, the fuse 10 blows and prevents overcurrent generation. In addition, an inductor 11 is also connected in series with the battery 1. In other words, the inverter device according to this embodiment is a DC input inverter device including a resonant circuit (the smoothing capacitors 3 and inductor 11), i.e., a so-called DC link resonant inverter device.

In this embodiment, a shunt resistor 12 is connected in series with each pair of the smoothing capacitors 3. The shunt resistors 12 are used to sense the values of electric currents flowing out of the negative terminals of the smoothing capacitors 3. However, the present invention is not limited to this. In place of the shunt resistors 12, different electric current sensing means such as electric current sensors may be used. A voltage sensor 13 (or a different voltage sensing means) is connected in parallel with the smoothing capacitors 3. The voltage sensor 13 monitors the voltage of the battery 1 and the voltage of the DC part of the inverter circuit 4, which will be described later (referred to as “DC voltage” below).

When the control unit 5 controls the on and off of the plurality of switching elements of the inverter circuit 4, as will be described later, AC components synchronized with the switching frequency (the pulse width modulation (referred to as “PWM” below) carrier frequency of the PWM signal), such as a ripple voltage or noise, are superimposed on the DC voltage. The smoothing capacitors 3 repeat charge and discharge cycles to supplement the DC voltage from the battery 1, and also reduce the ripple voltage, noise, and the like superimposed on the DC voltage. When the inverter device according to this embodiment is used in an air conditioner or the like that is driven using an AC power supply, the smoothing capacitors 3 reduce the ripple voltage superimposed on a voltage (DC voltage) into which an AC voltage is converted and rectified by a rectifier circuit, for example.

The inverter circuit 4 generates three-phase voltages Vu, Vv, Vw from the DC voltage supplied by the battery 1 or from the DC voltage having a ripple voltage reduced by the smoothing capacitors 3. The inverter circuit 4 supplies the three-phase voltages Vu, Vv, Vw to the electric motor 2 such as a three-phase brushless motor. As the plurality of switching elements, the inverter circuit 4 has three upper-arm switching elements (IGBTs) 40u, 40v, 40w and three lower-arm switching elements (IGBTs) 41u, 41v, 41w. In the inverter circuit 4, the emitters of the lower-arm switching elements 41u to 41w are connected to shunt resistors 42, 43, 44, respectively.

The control unit 5 is electrically connected to the inverter circuit 4, and controls the on and off of the switching elements 40u to 40w, 41u to 41w of the inverter circuit 4. Specifically, the control unit 5 controls the duty cycle of the PWM signal for turning on and off the six switching elements 40u to 40w, 41u to 41w of the inverter circuit 4 so as to control the electric current flowing through the electric motor 2. Thereby, the control unit 5 drives the electric motor 2 in an appropriate operational state.

The fault detection unit 6 is electrically connected to the shunt resistors 12, voltage sensor 13, and control unit 5 (see FIG. 1). Specifically, the fault detection unit 6 detects an open fault of the smoothing capacitors 3 based on the electric current values sensed by the shunt resistors 12. In this case, when detecting that no electric current flows out of any of the negative terminals of the smoothing capacitors 3, the fault detection unit 6 determines that an open fault has occurred in the smoothing capacitors 3.

However, the present invention is not limited to this. As an alternative, the fault detection unit 6 may detect an open fault of the smoothing capacitors 3 based on the ripple voltage value of the DC voltage, which is calculated by the voltage sensor 13. Specifically, the voltage sensor 13 senses the amplitude of the DC voltage with a sampling frequency that is twice (or greater than twice) the switching frequency of the inverter circuit 4 controlled by the control unit 5, and calculates the ripple voltage value based on the sensed amplitude. Then, the fault detection unit 6 determines whether or not the ripple voltage value thus calculated falls within a range defined by preset upper and lower limits, thus detecting whether or not an open fault has occurred in the smoothing capacitors 3. In this case, when detecting that the ripple voltage value is above the upper limit or below the lower limit, the fault detection unit 6 determines that an open fault has occurred in the smoothing capacitors 3.

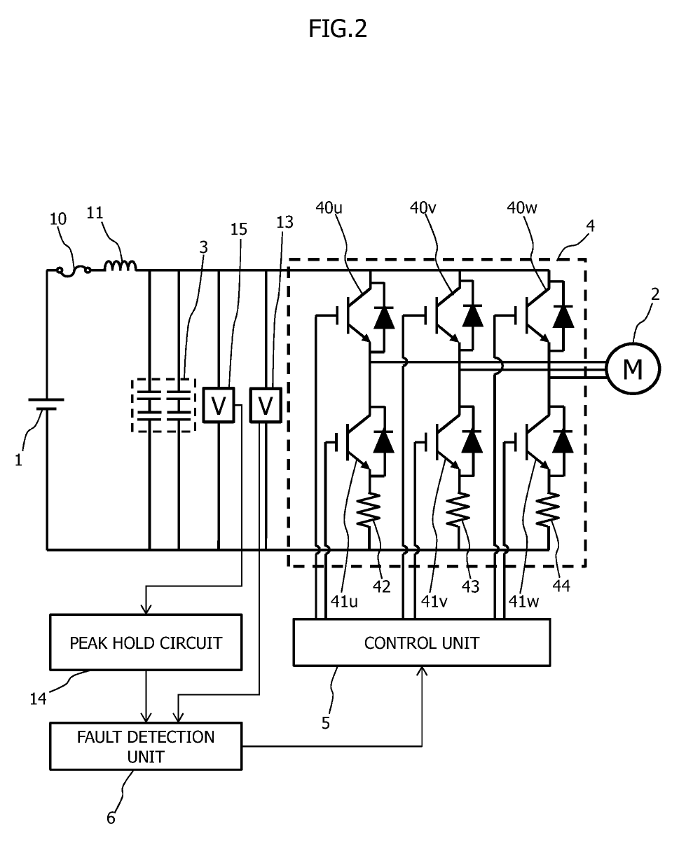

As another alternative, an open fault in the smoothing capacitors 3 may be detected by the following method, for example. FIG. 2 is a circuit diagram showing another schematic configuration of the inverter device. As shown in FIG. 2, in addition to the voltage sensor 13, a voltage sensor 15 with a peak hold circuit 14 is connected in parallel with the smoothing capacitors 3. The peak hold circuit 14, which is electrically connected to the fault detection unit 6, acquires the value of peak AC component from the DC voltage value sensed and output by the voltage sensor 15. Then, the peak hold circuit 14 outputs the peak value to the fault detection unit 6. In this case, the voltage sensor 13 senses the average DC voltage value. Thus, the fault detection unit 6 may calculate the ripple voltage value based on the peak value output by the peak hold circuit 14 and the average value sensed by the voltage sensor 13. Then, the fault detection unit 6 may determine whether or not the ripple voltage value thus calculated falls within the range defined by the preset upper and lower limits, thus detecting whether or not an open fault has occurred in the smoothing capacitors 3. In this case, when detecting that the ripple voltage value is above the upper limit or below the lower limit, the fault detection unit 6 determines that an open fault has occurred in the smoothing capacitors 3. When the voltage sensor 13 and the voltage sensor 15 with the peak hold circuit 14 are used to determine whether or not an open fault has occurred in the smoothing capacitors 3, the shunt resistors 12 may be omitted.

After the fault detection unit 6 determines whether or not an open fault has occurred in the smoothing capacitors 3 by using any of the above configurations, the fault detection unit 6 outputs, to the control unit 5, a signal indicating the result of the open fault detection in the smoothing capacitors 3.

In general, the voltage variation caused by controlling the on and off (switching) of the switching elements 40u to 40w, 41u to 41w of the inverter circuit 4, i.e., the ripple voltage superimposed on the DC voltage, is inversely proportional to the PWM carrier frequency of the PWM signal, and increases along with an increase in the electric current flowing through the electric motor 2. Thus, when an open fault has occurred in the smoothing capacitors 3, if an electric current as large as that set during normal operation is supplied to the electric motor 2, the ripple voltage of the DC voltage will exceed a preset allowable value. Such an excessive ripple voltage may damage the inductor 11, and electronic components and/or the like surrounding the inverter device, and may cause electromagnetic noise that adversely affects these surrounding electronic components and/or the like. To avoid these, when it is detected that an open fault has occurred in the smoothing capacitors 3, the inverter device according to this embodiment drives the electric motor 2 while limiting the electric current flowing through the electric motor 2 such that the ripple voltage of the DC voltage does not exceed the preset allowable value. Specifically, when an open fault has occurred in the smoothing capacitors 3, a limited electric current mode is performed. In the limited electric current mode, the control unit 5 limits the electric current flowing through the electric motor 2 by controlling the operation of the switching elements 40u to 40w, 41u to 41w of the inverter circuit 4.

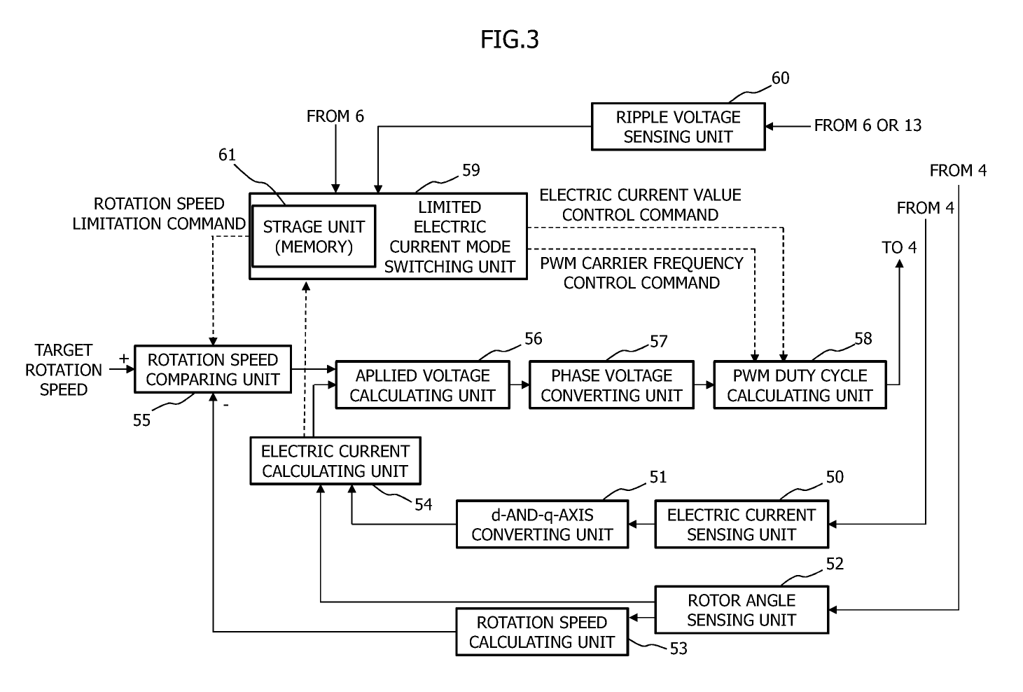

Next, the configuration of the control unit 5, which controls switching to the limited electric current mode, will be described with reference to FIG. 3. FIG. 3 is a block diagram showing a control circuit for the limited electric current mode in the control unit 5. As shown in FIG. 3, the control unit 5 includes an electric current sensing unit 50, a d-and-q-axis converting unit 51, a rotor angle sensing unit 52, a rotation speed calculating unit 53, an electric current calculating unit 54, a rotation speed comparing unit 55, an applied voltage calculating unit 56, a phase voltage converting unit 57, a PWM duty cycle calculating unit 58, a limited electric current mode switching unit 59, and a ripple voltage sensing unit 60.

The electric current sensing unit 50 senses three-phase currents Iu, Iv, Iw of the electric motor 2 based on electric currents flowing through the shunt resistors 42 to 44 connected to the emitters of the lower-arm switching elements 41u to 41w of the inverter circuit 4. The d-and-q-axis converting unit 51 converts the three-phase currents Iu, Iv, Iw into a d-axis current Id and a q-axis current Iq. The rotor angle sensing unit 52 senses the angle of the rotor by, for example, using a Hall sensor or calculates the rotor angle based on phase voltages and currents. The rotation speed calculating unit 53 calculates the rotation speed of the rotor based on the sensed rotor angle. The electric current calculating unit 54 calculates the value and phase delay or advance of the electric current flowing through the electric motor 2 based on the electric currents Id, Iq and the rotor angle, and outputs the thus calculated electric current value to the limited electric current mode switching unit 59. The rotation speed comparing unit 55 has a comparator for calculating and outputting the difference between the thus calculated rotation speed of the rotor and a target rotation speed. The applied voltage calculating unit 56 calculates voltages for driving the electric motor 2 (a d-axis voltage Vd and a q-axis voltage Vq) and adjusts the phases of the voltages. The phase voltage converting unit 57 converts the d-axis voltage Vd and q-axis voltage Vq to the three-phase voltages Vu, Vv, Vw. The PWM duty cycle calculating unit 58 calculates a duty cycle of the PWM signal based on the three-phase voltages Vu, Vv, Vw, and uses the PWM signal having the thus calculated duty cycle to selectively turn on the switching elements 40u to 40w, 41u to 41w of the inverter circuit 4.

When the signal indicating the result of the open fault detection of the smoothing capacitors 3 output by the fault detection unit 6 indicates that an open fault has occurred in the smoothing capacitors 3, the limited electric current mode switching unit 59 compares the value of the electric current flowing through the electric motor 2 output by the electric current calculating unit 54 with a preset electric current value, which will be described later. Then, when the output electric current value is above the preset electric current value, the limited electric current mode switching unit 59 outputs a limitation command for the limited electric current mode. The limited electric current mode switching unit 59 has a storage unit (memory) 61 containing data such as a table, which will be described later. Examples of the limitation command include a rotation speed limitation command to be output to the rotation speed comparing unit 55, an electric current value limitation command to be output to the PWM duty cycle calculating unit 58, and a PWM carrier frequency control command to be output to the PWM duty cycle calculating unit 58. The ripple voltage sensing unit 60 senses the ripple voltage of the DC voltage calculated by the voltage sensor 13 or fault detection unit 6, and outputs the sensed value of the ripple voltage to the limited electric current mode switching unit 59.

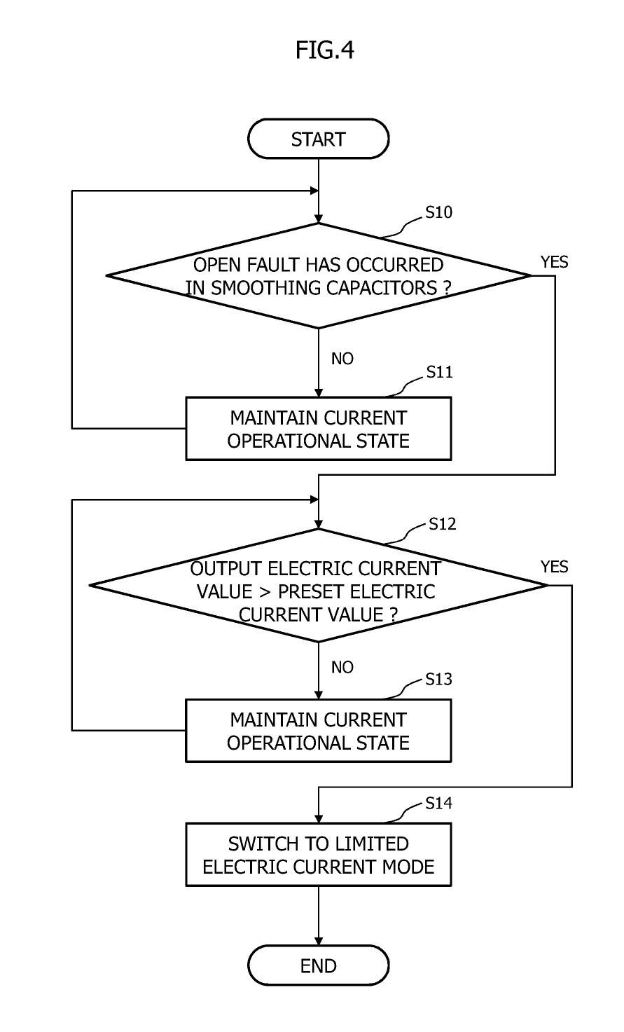

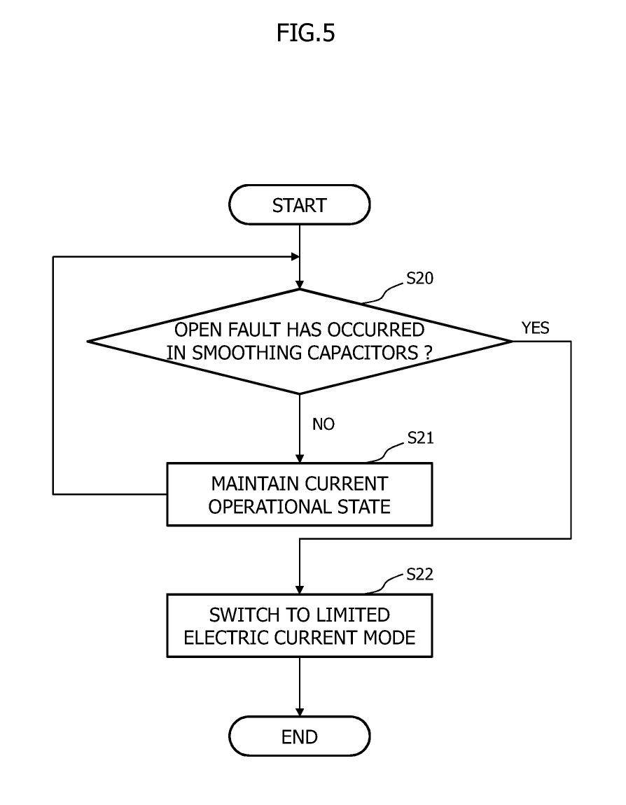

Below, how the control unit 5 configured as above switches to the limited electric current mode will be described with reference to FIG. 4. FIG. 4 is a flowchart showing the procedure for switching to the limited electric current mode. Note that the control described below is performed by the control unit 5 while the electric motor 2 operates normally.

In step S10, the control unit 5 determines whether or not an open fault has occurred in the smoothing capacitors 3. Specifically, in step S10, the fault detection unit 6 determines whether or not an open fault has occurred in the smoothing capacitors 3 by at least one of the above open fault detection methods. When the fault detection unit 6 determines that no open fault has occurred in the smoothing capacitors 3, the result in step S10 is “NO” and the operation proceeds to step S11. In step S11, the control unit 5 maintains the electric motor 2 in the current operational state, and the operation returns to step S10. In step S10, the control unit 5 determines whether or not an open fault has occurred in the smoothing capacitors 3, again. On the other hand, when the fault detection unit 6 determines that an open fault has occurred in the smoothing capacitors 3, the result in step S10 is “YES” and the operation proceeds to step S12.

In step S12, the control unit 5 determines whether or not the value of the electric current flowing through the electric motor 2 calculated by the electric current calculating unit 54 is above the preset electric current value. For example, the preset electric current value is a constant electric current value for driving the electric motor 2 in a manner that the ripple voltage of the DC voltage does not exceed the preset allowable value, and is determined in advance and stored in the memory 61. As an alternative, the preset electric current value may be an electric current value varying according to a table that is prepared through experiments in advance and stored in the memory 61. However, the present invention is not limited to these. The preset electric current value may vary depending on the monitored value of the ripple voltage of the DC voltage sensed by the ripple voltage sensing unit 60 rather than according to the table. When the electric current value is equal to or below the preset electric current value (when the value of the electric current flowing through the electric motor 2≤the preset electric current value holds), the result in step S12 is “NO” and the operation proceeds to step S13.

In step S13, the control unit 5 maintains the electric motor 2 in the current operational state, and the operation returns to step S12. In step S12, the control unit 5 determines whether or not the value of the electric current flowing through the electric motor 2 is above the preset electric current value, again. In other words, even when an open fault has occurred in the smoothing capacitors 3, as long as the value of the electric current flowing through the electric motor 2 is equal to or below the preset electric current value, there is no risk that the ripple voltage of the DC voltage will adversely affect the electronic components and/or the like surrounding the inverter device. Thus, in such a case, the control unit 5 maintains the electric motor 2 in the current operational state. However, there remains a risk that the value of the electric current flowing through the electric motor 2 increases along with a change in the operational state of the electric motor 2. This is why the control unit 5 performs the determination in step S12, again. On the other hand, when the control unit 5 determines that the value of the electric current flowing through the electric motor 2 is above the preset electric current value (when the value of the electric current flowing through the electric motor 2 >the preset electric current value holds), the result in step S12 is “YES” and the operation proceeds to step S14. In step S14, the control unit 5 switches to the limited electric current mode.

Below, how the limited electric current mode is performed based on the rotation speed limitation command will be described. When the result in step S12 is “YES”, the control unit 5 turns on the limited electric current mode switching unit 59, and thereby selects the limited electric current mode based on the rotation speed limitation command. In response, the limited electric current mode switching unit 59 outputs the rotation speed limitation command to the rotation speed comparing unit 55, and the control unit 5 retrieves the preset rotation speed from the memory 61. Then, the operation proceeds to step S14.

In step S14, based on the rotation speed limitation command, the control unit 5 sets a rotation speed of the electric motor 2 to a rotation speed which is equal to or below the preset rotation speed that is retrieved from the memory 61, and drives the electric motor 2. The preset rotation speed is, for example, a constant rotation speed that allows driving the electric motor 2 while limiting the electric current flowing through the electric motor 2 such that the ripple voltage of the DC voltage does not exceed the preset allowable value. Specifically, the preset rotation speed is set lower than a rotation speed set while the electric motor 2 operates normally. As an alternative, the preset rotation speed may be a rotation speed varying according to a table that is prepared through experiments in advance and stored in the memory 61. However, the present invention is not limited to these. The preset rotation speed may vary depending on the monitored value of the ripple voltage of the DC voltage sensed by the ripple voltage sensing unit 60 rather than according to the table.

After that, the electric current sensing unit 50 senses the three-phase currents Iu, Iv, Iw based on the electric currents flowing through the shunt resistors 42 to 44 connected to the emitters of the lower-arm switching elements 41u to 41w of the inverter circuit 4. Then, the d-and-q-axis converting unit 51 converts the three-phase currents Iu, Iv, Iw into the d-axis current Id and q-axis current Iq. Then, the electric current calculating unit 54 calculates the value and phase delay or advance of the electric current flowing through the electric motor 2 based on the electric currents Id, Iq and the rotor angle sensed by the rotor angle sensing unit 52. At the same time, the rotation speed calculating unit 53 calculates the actual rotation speed of the rotor based on the rotor angle sensed by the rotor angle sensing unit 52. After that, the rotation speed comparing unit 55 calculates and outputs the difference between the actual rotation speed and the preset rotation speed. Then, based on the electric current value calculated by the electric current calculating unit 54 and the difference between the actual and preset rotation speeds output by the rotation speed comparing unit 55, the applied voltage calculating unit 56 calculates the applied voltages Vd, Vq for driving the electric motor 2.

The phase voltage converting unit 57 converts the applied voltages Vd, Vq to the three-phase voltages Vu, Vv, Vw. The PWM duty cycle calculating unit 58 calculates the duty cycle of the PWM signal based on these three-phase voltages Vu, Vv, Vw, and uses the PWM signal having this duty cycle to selectively turn on the switching elements 40u to 40w, 41u to 41w of the inverter circuit 4. In this way, the control unit 5 limits the electric current flowing through the electric motor 2 equal to or below the preset electric current value such that the electric motor 2 rotates at a speed equal to or below the preset rotation speed. The above flow continues and the control unit 5 continues to drive the electric motor 2 in the limited electric current mode until the operation switch of the electric motor 2 is turned off

Below, how the limited electric current mode is performed based on the electric current value limitation command in place of the rotation speed limitation command in step S14 will be described. When the limited electric current mode is performed based on the electric current value limitation command in step S14, the above flow is modified as follows. When the result in step S12 is “YES”, the limited electric current mode switching unit 59 outputs the electric current value limitation command to the PWM duty cycle calculating unit 58. In step S14, the control unit 5 adjusts the duty cycle for driving the switching elements 40u to 40w, 41u to 41w which is calculated by the PWM duty cycle calculating unit 58 such that the electric current caused to flow through the electric motor 2 based on the duty cycle is limited equal to or below the preset electric current value.

Specifically, the duty cycle calculated by the PWM duty cycle calculating unit 58 is changed to a value lower than the duty cycle used while the electric motor 2 operates normally such that the electric current flowing through the electric motor 2 is equal to or below the preset electric current value. After that, based on the three-phase currents Iu, Iv,

Iw, rotor angle, and target rotation speed thus sensed, the control unit 5 calculates a duty cycle low enough to limit the electric current flowing through the electric motor 2 equal to or below the preset electric current value. The control unit 5 uses the PWM signal having this duty cycle to selectively turn on the switching elements 40u to 40w, 41u to 41w of the inverter circuit 4. In this way, the control unit 5 drives the electric motor 2 while limiting the electric current flowing through the electric motor 2 equal to or below the preset electric current value. After that, the electric motor 2 rotates while maintaining a rated rotation speed with the electric current limited as above.

Below, how the limited electric current mode is performed based on the PWM carrier frequency control command in place of the rotation speed limitation command in step S14 will be described. In the limited electric current mode based on the PWM carrier frequency control command, the electric current flowing through the electric motor 2 is limited based on the PWM carrier frequency of the PWM signal for driving the switching elements 40u to 40w, 41u to 41w. In this case, the above flow is modified as follows. In step S14, the PWM duty cycle calculating unit 58 sets the PWM carrier frequency to a value equal to or above a preset frequency. The preset frequency is a constant PWM carrier frequency preset for driving the electric motor 2 while limiting the electric current flowing through the electric motor 2 such that the ripple voltage of the DC voltage does not exceed the preset allowable value. Specifically, the preset frequency is set higher than the PWM carrier frequency used while the electric motor 2 operates normally. As an alternative, the preset frequency may be a carrier frequency varying according to a table that is prepared through experiments in advance and stored in the memory 61. However, the present invention is not limited to these. The preset frequency may vary depending on the monitored value of the ripple voltage of the DC voltage sensed by the ripple voltage sensing unit 60 rather than according to the table.

After that, based on the three-phase currents Iu, Iv, Iw, rotor angle, and target rotation speed thus sensed, the control unit 5 calculates a duty cycle of the PWM signal generated based on the preset frequency. The control unit 5 uses the PWM signal having the thus calculated duty cycle to selectively turn on the switching elements 40u to 40w, 41u to 41w of the inverter circuit 4. In this way, the electric motor 2 rotates while maintaining its rotation speed at the target rotation speed. Specifically, the PWM carrier period based on the PWM carrier frequency that is set lower than the above preset frequency is shorter than that used while the electric motor 2 operates normally, so that the on period of each of the switching elements 40u to 40w, 41u to 41w based on the duty cycle is reduced as compared to while the electric motor 2 operates normally. In other words, the duration for which the electric current flowing through the electric motor 2 increases is reduced, and thus variation in the electric current is reduced. As a result, the electric current flowing through the electric motor 2 is limited such that the ripple voltage of the DC voltage does not exceed the preset allowable value.

As described above, according to this embodiment, when an open fault has occurred in the smoothing capacitors 3 and when the electric current flowing through the electric motor 2 is above the preset electric current value, the electric motor 2 is driven in the limited electric current mode based on the rotation speed limitation command, electric current value limitation command, or PWM carrier frequency control command. As a result, the electric motor 2 is driven while the electric current flowing through the electric motor 2 is limited such that the ripple voltage of the DC voltage does not exceed the preset allowable value. This allows the inverter device to drive the electric motor 2 as long as possible while protecting the inductor 11 and the electronic components and/or the like surrounding the inverter device from damage caused by an excessive ripple voltage and adverse effects of electromagnetic noise. In other words, even after an open fault has occurred in the smoothing capacitors 3, the limited electric current mode maintains the air conditioner in an operating state, thus maintaining the vehicle interior in a comfortable condition as long as possible.

In the above embodiment, when the control unit 5 determines that an open fault has occurred in the smoothing capacitors 3 in step S10, the control unit 5 determines whether or not the value of the electric current flowing through the electric motor 2 is above the preset electric current value in step S12. In this way, the electric motor 2 is maintained in the current operational state as long as possible even after an open fault has occurred in the smoothing capacitors 3. However, the present invention is not limited to this. For example, as shown in FIG. 5, when the control unit 5 determines that an open fault has occurred in the smoothing capacitors 3 in step S20, the operation may skip step S12 shown in FIG. 4 and proceed to step S22. Thereby, immediately after such determination, the limited electric current mode is performed based on the rotation speed limitation command, electric current value limitation command, or PWM carrier frequency control command. This allows more effective protection of the inductor 11 and the electronic components and/or the like surrounding the inverter device from damage caused by an excessive ripple voltage and adverse effects of electromagnetic noise. In this case, when the signal output by the fault detection unit 6 indicates that an open fault has occurred in the smoothing capacitors 3, the limited electric current mode switching unit 59 outputs the rotation speed limitation command, electric current value limitation command, or PWM carrier frequency control command upon receipt of this signal.

In the embodiments described above, when the control unit 5 determines that an open fault has occurred in the smoothing capacitors 3 in step S10 or S20, a warning sign may be displayed on the display unit of the dashboard or a warning sound may be output so as to notify the vehicle occupant (e.g., driver) that the open fault has occurred in the smoothing capacitors 3. Note, however, that the method for notifying such open fault occurrence is not limited to these. The notification of the open fault occurrence in the smoothing capacitors 3 may be output when the control unit 5 switches to the limited electric current mode in step S14 after the control unit 5 determines that the electric current flowing through the electric motor 2 is above the preset electric current value in step S12.

Moreover, in the embodiments described above, the electric current flowing through the electric motor 2 is limited according to the single limited electric current mode based on either the rotation speed limitation command or the electric current value limitation command (the duty cycle adjustment or the PWM carrier frequency setting). However, the present invention is not limited to these. For example, the limited electric current modes based on any of the rotation speed limitation command, the duty cycle adjustment, and the PWM carrier frequency setting may be used in combination in accordance with necessities. As yet another alternative, at least two of the rotation speed limitation command, the duty cycle adjustment, and the PWM carrier frequency setting may be selected, and the control unit 5 operates for a predetermined time in each of the limited electric current modes based on these selected methods.

In the embodiments described above, the electric current flowing through the electric motor 2 is limited based on the electric currents flowing through the shunt resistors 42 to 44 connected to the emitters of the lower-arm switching elements 41u to 41w of the inverter circuit 4. However, the present invention is not limited to this. For example, the electric current flowing through the electric motor 2 may be limited based on the electric current flowing through a shunt resistor disposed on the ground line of the inverter circuit 4 or the electric currents flowing through the shunt resistors 12 connected to the negative terminals of the smoothing capacitors 3.

Alternatively, the shunt resistor 12 or a different electric current sensing means such as an electric current sensor may be connected in series with each of the four smoothing capacitors 3 in the embodiments described above. In this case, when the electric current through at least one of the smoothing capacitors 3 stops, it may be determined that an open fault has occurred in the at least one of the smoothing capacitors 3.

In the embodiments described above, the three-phase inverter circuit 4 is used. However, the present invention is not limited to this. The inverter circuit 4 may have any number of phases, such as four phases. The number of phases of the inverter circuit 4 may be appropriately selected according to the number of phases of the electric motor for which the inverter circuit 4 is used.

### REFERENCE SYMBOL LIST

1 battery
2 electric motor
3 smoothing capacitor
4 inverter circuit
5 control unit
6 fault detection unit
10 fuse
11 inductor
12 shunt resistor (electric current sensing means)
13 voltage sensor (voltage sensing means)
40u to 40w upper-arm switching element
41u to 41w lower-arm switching element
42 to 44 shunt resistor

1. An inverter device that generates an AC voltage from a DC voltage and drives an electric motor, comprising:
a smoothing capacitor for reducing a ripple voltage superimposed on the DC voltage,
wherein, when an open fault has occurred in the smoothing capacitor, the inverter device drives the electric motor while limiting an electric current flowing through the electric motor such that the ripple voltage of the DC voltage does not exceed a preset allowable value.

2. The inverter device according to claim 1, wherein, when an open fault has occurred in the smoothing capacitor and when the electric current flowing through the electric motor is above a preset electric current value, the inverter device limits the electric current flowing through the electric motor such that the ripple voltage of the DC voltage does not exceed the preset allowable value.

3. The inverter device according to claim 1, wherein the inverter device limits the electric current flowing through the electric motor by setting a rotation speed of the electric motor to a rotation speed which is equal to or below a preset rotation speed.

4. The inverter device according to claim 1, comprising:
an inverter circuit having a plurality of switching elements; and
a control unit for controlling operation of the plurality of switching elements of the inverter circuit,
wherein, when an open fault has occurred in the smoothing capacitor, the control unit limits the electric current flowing through the electric motor by controlling the operation of the plurality of switching elements.

5. The inverter device according to claim 4, wherein the control unit limits the electric current flowing through the electric motor by adjusting a duty cycle of a pulse width modulation signal for driving the switching elements.

6. The inverter device according to claim 4, wherein the control unit limits the electric current flowing through the electric motor by setting a pulse width modulation carrier frequency of a pulse width modulation signal for driving the switching elements to a value equal to or above a preset frequency.
